(19) United States
(12) Patent Application Publication
(10) Pub. No.: US 2016/0320114 A1
(43) Pub. Date: Nov. 3, 2016

(54) FLOW RATE MEASURING DEVICE AND VARIABLE DISPLACEMENT COMPRESSOR

(71) Applicant: SANDEN HOLDINGS CORPORATION, Isesaki-shi, Gunma (JP)

(72) Inventors: Takahiro Ito, Isesaki-shi (JP); Yukihiko Taguchi, Isesaki-shi (JP)

(73) Assignee: Sanden Holdings Corporation, Isesaki-shi (JP)

(21) Appl. No.: 15/108,088

(22) PCT Filed: Dec. 18, 2014
(86) PCT No.: PCT/JP2014/083563

§ 371 Date: Jun. 24, 2016

(30) Foreign Application Priority Data
Dec. 26, 2013 (JP) 2013-268650

(51) Int. Cl. F25B 49/02; G01F 1/38; F04B 49/06

(52) U.S. Cl. CPC F25B 49/022; F04B 49/06; G01F 1/38; F25B 2700/13

(57) ABSTRACT

In a flow rate measuring device for measuring a refrigerant discharge flow rate in a variable displacement compressor, a check valve is used as a throttle for measuring the flow rate to thereby simplify the configuration while an anti-backflow function of the check valve is secured. The device includes a spool 252 receiving, at one pressure receiving surface, a pressure on an upstream side of the check valve and, at an opposite pressure receiving surface, a pressure on a downstream side to slide in a housing 251 such that a differential pressure therebetween balances a biasing force of a compression coil spring 253, and a sensor detecting a position of the spool 252 to measure the flow rate (magnetic force measuring unit 256). The housing 251 includes a position regulation part (regulation surface 251a3) which regulates a position of the spool 252 to close a gap between the hosing 251 and the spool 252 when the differential pressure falls below a predetermined value.

### TECHNICAL FIELD

The present invention relates to a flow rate measuring device configured to measure the flow rate of fluid such as refrigerant flowing through a refrigerant passage and to a variable displacement compressor equipped with the flow rate measuring device.

### BACKGROUND ART

Some variable displacement compressors used for an in-vehicle air conditioner incorporate a device for measuring the discharge flow rate of refrigerant in order to measure the drive load of the compressor. And, some of these variable displacement compressors are provided with a check valve that prevents refrigerant from flowing back to the compressor from an external refrigerant circuit during the suspension period, etc.

Patent Document 1 discloses the following. That is, an elastically deformable throttle is disposed in the refrigerant discharge passage. While changing the passage cross-section area for fluid according to the degree by which the throttle elastically deforms, the throttle optionally functions to measure the refrigerant flow rate based on the differential pressure between the upstream and downstream sides of the throttle. The differential pressure varies depending on the degree by which the throttle elastically deforms. Moreover, the throttle also functions as the check valve to thereby simplify the configuration.

Patent Document 2 discloses a method for measuring the refrigerant flow rate by detecting the position of a spool inserted into a cylinder that is provided bypassing the throttle, the spool being slidable inside the cylinder according to the differential pressure between the upstream and downstream sides of the throttle.

### REFERENCE DOCUMENT LIST

### Patent Documents

Patent Document 1: JP 2003-176779 A

Patent Document 2: JP 2007-211703 A

### SUMMARY OF THE INVENTION

### Problems to be Solved by the Invention

However, if the throttle functions as the check valve as in Patent Document 1, for example, in the method for measuring the refrigerant flow rate by detecting the position of the spool as in Patent Document 2, the upstream side of the check valve (fluid supply hole 47) and the downstream side thereof (fluid supply hole 50) are communicating with each other all the time by way of a gap between the outer periphery (cylindrical portion 42) of a spool 41 and the inner periphery of a sealed chamber 36. Accordingly, even after the check valve is closed, the refrigerant might, although in a small quantity, flow from the downstream side of the check valve to the upstream side thereof bypassing the check valve.

For example, if the variable displacement compressor is suspended for the long time, a temperature difference occurs between a compressor and a heat exchanger of an air conditioning system along with the change in ambient temperature. This might lead to a pressure difference inside the air conditioning system. When such pressure difference occurs, even if the check valve is closed, the refrigerant in the heat exchanger may pass through the gap between the outer periphery of the spool and the inner periphery of the sealed chamber and then flow into the variable displacement compressor. As a result, the variable displacement compressor may retain the liquid refrigerant. Especially if a crankcase retains the liquid refrigerant, when the variable displacement compressor resumes the operation, the discharge capacity does not increase until the liquid refrigerant is discharged. Thus, the air conditioning system cannot start operating immediately.

It is an object of the present invention to provide a flow rate measuring device which realizes the simplified configuration by using a check valve as a throttle for measuring a flow rate and secures the anti-backflow function of the check valve.

### Means for Solving the Problems

In order to attain the above object, the present invention provides a flow rate measuring device that measures a flow rate of fluid passing through a fluid passage which includes a check valve that opens/closes according to a differential pressure between an upstream pressure and a downstream pressure, the device including: a spool configured to receive, at one pressure receiving surface, a pressure on an upstream side of the check valve and, at an opposite pressure receiving surface, a pressure on a downstream side of the check valve to slide in a cylinder such that a differential pressure therebetween balances a biasing force of a spring; and a sensor configured to detect a position of the spool to measure the flow rate, wherein the cylinder includes a position regulation part configured to regulate the position of the spool in an axial direction of the spool to close a gap between the cylinder and the spool when the differential pressure is equal to or less than a predetermined value.

Furthermore, the present invention provides a variable displacement compressor including the flow rate measuring device according to the present invention, which is provided on a discharge passage through which a discharge chamber communicates with an external refrigerant circuit.

### Effects of the Invention

In the flow rate measuring device according to the present invention, the check valve doubles as a throttle for measuring the flow rate, contributing to the simplified configuration. In addition, when a differential pressure between the upstream and downstream sides of the check valve falls below a predetermined value, the position of the spool is regulated to thereby close a gap between the cylinder and the spool. This configuration can prevent fluid from leaking from the gap at the time of closing the check valve and also secure the anti-backflow function of the check valve.

In the variable displacement compressor according to the present invention, the thus-simplified flow rate measuring device is disposed in the compressor, making it possible to simplify the configuration of the compressor main body and also prevent liquid refrigerant from flowing back from an external refrigerant circuit and remaining in the compressor at the time of closing the check valve, that is, when the compressor is suspended. As a result, the air conditioning system can start up quickly after restarting the compressor. On the other hand, the variable displacement compressor rarely makes intermittent stops and thus makes it possible to stably measure the flow rate. Such a compressor is suitable as the one equipped with a flow rate measuring device.

### BRIEF DESCRIPTION OF THE DRAWINGS

FIG. 1 is a cross-sectional view of the internal configuration of a variable displacement compressor according to an embodiment of the present invention.

FIG. 2 is an enlarged cross-sectional view of the main part of FIG. 1.

FIG. 3 is a partially cross-sectional view of the internal configuration of a check valve used in the compressor.

FIG. 4 is a cross-sectional view showing the internal configuration of a control valve used in the compressor.

FIGS. 5A and 5B are cross-sectional views showing the internal configuration of a flow rate measuring device used in the compressor, in which FIG. 5A illustrates a spool being in abutment with a regulation surface and FIG. 5B illustrates the spool being away from the regulation surface to measure the flow rate.

### MODE FOR CARRYING OUT THE INVENTION

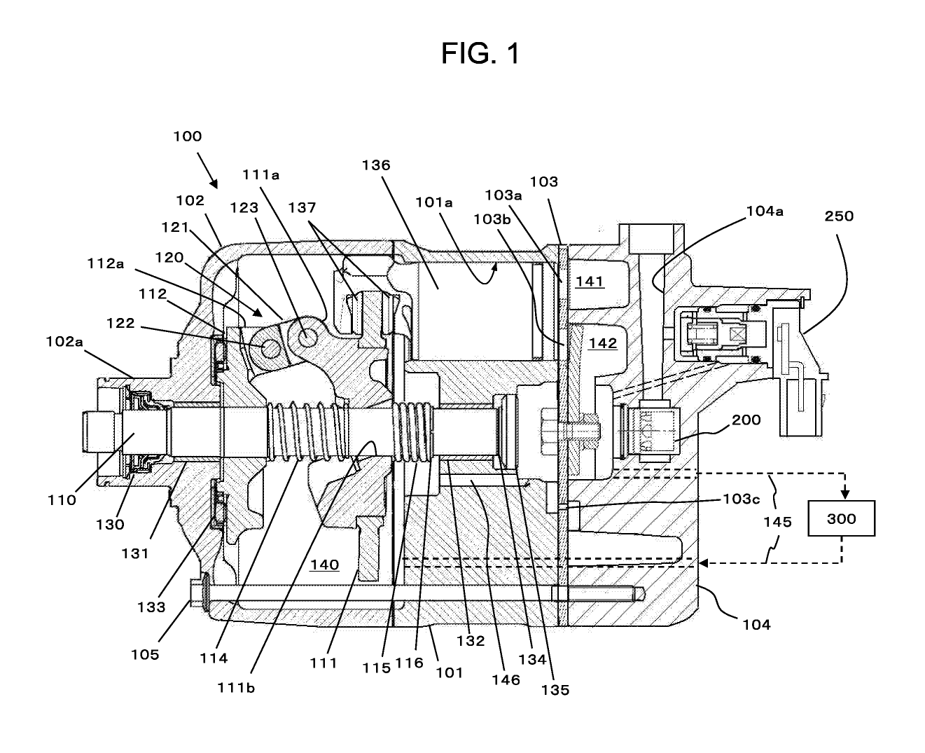

Hereinafter, embodiments of the present invention will be described with reference to the accompanying drawings. FIG. 1 illustrates the internal configuration of a variable displacement compressor according to the present invention. A variable displacement compressor 100 is a clutchless compressor, including a cylinder block 101 having plural cylinder bores 101a formed on the periphery, a front housing 102 connected to one end of the cylinder block 101, and a cylinder head 104 connected to the other end of the cylinder block 101 by means of a valve plate 103.

A drive shaft 110 extends across an inner space of a crankcase 140 defined by the cylinder block 101 and the front housing 102. A swash plate 111 is provided around the central portion of the drive shaft 110 in the axial direction thereof. The swash plate 111 is connected to a rotor 112 fixed to the drive shaft 110 by way of a link mechanism 120. The swash plate 111 can change its angle (inclination angle) relative to the axial line of the drive shaft 110.

The link mechanism 120 includes a first arm 112a protruding from the rotor 112, a second arm 111a protruding from the swash plate 111, and a link arm 121 having one end rotatably connected to the first arm 112a by means of a first connecting pin 122 and the other end rotatably connected to the second arm 111a by means of a second connecting pin 123.

The swash plate 111 has a through hole 111 b that allows the swash plate 111 to incline at varying angles within the range from the minimum inclination angle to the maximum inclination angle. The through hole 111 b includes the minimum inclination angle regulation part capable of abutting the drive shaft 110. Provided that the inclination angle of the swash plate 111 perpendicular to the drive shaft 110 is defined by 0°, the minimum inclination angle regulation part of the through hole 111b allows the swash plate 111 to incline almost at 0°. The maximum inclination angle of the swash plate 111 is regulated by the swash plate 111 partially abutting the rotor 112.

A disinclining spring 114 is interposed between the rotor 112 and the swash plate 111. The spring 114 biases the swash plate 111 up to the minimum inclination angle. Moreover, an inclining spring 115 is interposed between the swash plate 111 and a spring support member 116. The spring 115 biases the swash plate 111 to increase the inclination angle thereof. The biasing force of the inclining spring 115 exceeds that of the disinclining spring 114 when the plate 111 is at the minimum inclination angle. Thus, if the drive shaft 110 is not revolving, the swash plate 111 is at such posture as makes the biasing force of the disinclining spring 114 well-balanced with that of the inclining spring 115.

The drive shaft 110 passes, at one end, through a boss 102a protruding from the front housing 102 and extends to the outside thereof. The shaft 110 is connected to a power transmission device (not shown). Here, a shaft seal device 130 is inserted between the drive shaft 110 and the boss 102a to shield the inside from the outside. A connected body of the drive shaft 110 and the rotor 112 is supported by bearings 131 and 132 in a radial direction and by a bearing 133 and a thrust plate 134 in a thrust direction. An adjusting screw 135 adjusts a gap between the thrust plate 134 and an abutment portion of the drive shaft 110 against the thrust plate 134 to a predetermined value. Thus, power is transmitted from an external drive source to the power transmission device, making it possible to revolve the drive shaft 110 in sync with the power transmission device.

A piston 136 is provided inside the cylinder bore 101a. The outer peripheral portion of the swash plate 111 is accommodated in an inner space of an end portion of the piston 136 which protrudes toward the crankcase 140. The swash plate 111 is operated together with the piston 136 by means of a pair of shoes 137. Thus, along with the rotation of the swash plate 111, the piston 136 can move to and fro inside the cylinder bore 101a.

The cylinder head 104 includes, at its center, a discharge chamber 142 and a suction chamber 141 encircling the discharge chamber 142. The suction chamber 141 is communicating with the cylinder bore 101a through an suction hole 103a of the valve plate 103 and a suction valve (not shown). The discharge chamber 142 is communicating with the cylinder bore 101a through a discharge valve (not shown) and a discharge hole 103b of the valve plate 103.

The maximum opening of the discharge valve (not shown) is regulated by a retainer 150. The maximum opening of the suction valve (not shown) is regulated by a cavity (not shown) formed on an end surface of the cylinder bore 101a. The suction valve (not shown), the valve plate 103, the discharge valve (not shown), and the retainer 150 are fastened integrally by a fastening member 151. The fastening member 151 is composed of, for example, a bolt, a nut, and a washer.

The front housing 102, a center gasket (not shown), the cylinder block 101, a cylinder gasket (not shown), the valve plate 103, a head gasket (not shown), and the cylinder head 104 are fastened by plural through bolts 105 to thereby constitute a compressor housing.

The cylinder head 104 is provided with a suction passage (not shown) through which a low-pressure refrigerant circuit of the air conditioning system communicates with the suction chamber 141. Owing to the passage, the suction chamber 141 is connected to the low-pressure refrigerant circuit of the air conditioning system.

In addition, the discharge chamber 142 is connected to a high-pressure external refrigerant circuit of the air conditioning system by way of an accommodating chamber 104b and a discharge passage 104a. The discharge passage 104a extends from the radially outer side of the cylinder head 104 across the suction chamber 141 toward the discharge chamber 142. The accommodating chamber 104b is disposed communicating with the discharge chamber 142 at the upstream side and communicating with the discharge passage 104a at the downstream side.

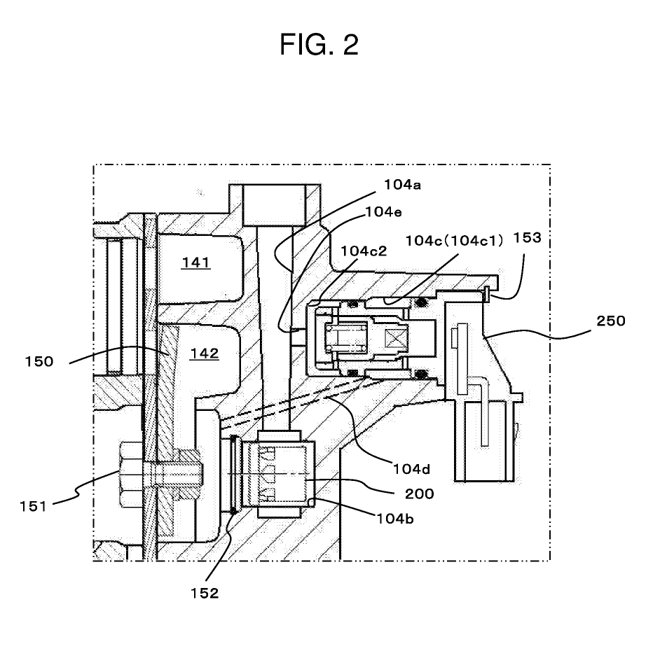

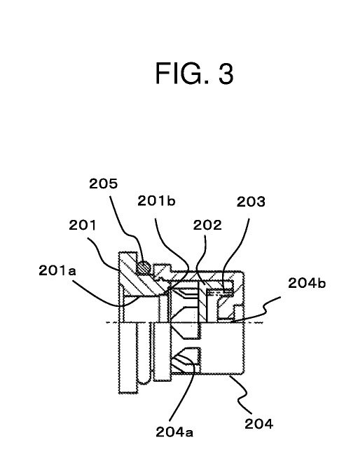

The cylinder head 104 includes a check valve 200 for opening/closing the discharge passage 104a. FIG. 2 is an enlarged view illustrating the peripheral portion of the check valve 200. FIG. 3 illustrates the internal configuration of the check valve 200.

The check valve 200 is composed of a valve seat forming member 201, a valve member 202, a compression coil spring 203, a bottomed cylindrical housing 204, and an O ring 205. The valve seat forming member 201 includes an inlet hole 201a and a valve seat 201b. The valve member 202 can, at one end surface, come into or out of contact with the valve seat 201b. The compression coil spring 203 biases the valve member 202 toward the valve seat 201b. The housing 204 accommodates the valve member 202 and the compression coil spring 203 and also has plural outlet holes 204a formed at the peripheral wall thereof and an open end fixed to the valve seat forming member 201. The check valve 200 is disposed inside the accommodating chamber 104b formed in the cylinder head 104 such that the inlet hole 201a communicates with the discharge hole 142 on the upstream side and the outlet hole 204a communicates with the discharge passage 104a on the downstream side. The snap ring 152 prevents the valve from coming off.

A through hole 204b is formed on the bottom wall of the housing 204. The other end surface of the valve member 202 receives the pressure in the accommodating chamber 104b, that is, the discharge passage 104a downstream of check valve 200. Furthermore, the one end surface of the valve member 202 receives the pressure of the inlet hole 201a, that is, the pressure from the discharge chamber 142 upstream of the check valve 200. Accordingly, the check valve 200 opens/closes the discharge passage 104a according to a differential pressure applied to the valve member 202 corresponding to the pressure difference between the discharge chamber 142 and the discharge passage 104a downstream of the check valve 200. If the differential pressure exceeds a predetermined differential pressure for opening a valve, the valve member 202 moves toward the bottom wall of the housing 204. Then, the inlet hole 201a communicates with the outlet hole 204a to open the discharge passage 104a. If the differential pressure falls below the differential pressure for opening a valve, the valve member 202 lies on the valve seat 201b, interrupting the communication between the inlet hole 201a and the outlet hole 204a. The discharge passage 104a is thus closed. The differential pressure for opening a valve is previously determined according to the biasing force of the compression coil spring 203. Therefore, if the differential pressure falls below the preset differential pressure for opening a valve, the discharge passage 104a is closed to prevent refrigerant from flowing from the high-pressure external refrigerant circuit to the discharge chamber 142.

In addition, disposed in the cylinder head 104 is a differential pressure measuring unit 250 for measuring a pressure difference between the upstream and downstream sides of the check valve 200 to thereby measure the flow rate of the refrigerant flowing through the discharge passage 104a.

The check valve 200 also functions as a throttle for measuring the flow rate. The check valve 200 and the differential pressure measuring unit 250 constitute a flow rate measuring device. The variable displacement compressor 100 continuously operates as the discharge capacity is varying, and thus rarely makes intermittent stops. Therefore, the compressor 100 is suitable for a compressor equipped with the flow rate measuring device. Note that the differential pressure measuring unit 250 is detailed later.

The cylinder head 104 further includes a control valve 300. The control valve 300 adjusts the opening of a pressure supply passage 145 through which the discharge chamber 142 communicates with the crankcase 140 to thereby control an amount of discharge gas introduced to the crankcase 140.

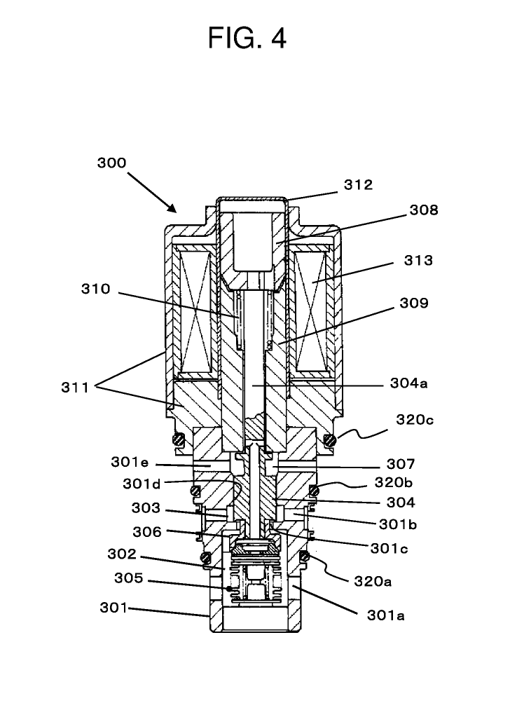

FIG. 4 illustrates the internal configuration of the control valve 300. The control valve 300 includes a first pressure sensing chamber 302, a valve hole 301c, a cylindrical valve member 304, a bellows assembly 305, a connecting part 306, and a second pressure sensing chamber 307. The first pressure sensing chamber 302 is disposed in a valve housing 301, communicating with the crankcase 140 through the communication hole 301a. The valve hole 301c has one end open at the first pressure sensing chamber 302 and the other end open at a valve chamber 303 communicating with the discharge chamber 142 through the communication hole 301b. The cylindrical valve member 304 has one end extending to the valve chamber 303 and functioning to open/close the valve hole 301c and has the other end slidably supported to a support hole 301d. The bellows assembly 305 is disposed in the first pressure sensing chamber 302 and configured to receive the pressure in the crankcase 140 by way of the communication hole 301a and function as a pressure sensing unit equipped with a spring in a vacuum inner space. The connecting part 306 has one end detachably connected to the bellows assembly 305 and the other end fixed to one end of the valve member 304. The second pressure sensing chamber 307 communicates with the suction chamber 141 through a communication hole 301e with the other end of the valve member 304 disposed therein

The support hole 301d is formed in the valve housing 301 and configured to slidably support the other end of the valve member 304. Since the valve member 304 is slidably supported to the support hole 301d with little gap, the valve member 304 is shielded at its other end from the valve chamber 303.

The control valve 300 further includes a solenoid rod 304a, a fixed core 309, a spring 310, a cylindrical member 312, and a magnetic coil 313. The rod 304a is integrated with the valve member 304. A movable core 308 is press-fitted to its end movable away from the valve member 304. The fixed core 309 has the solenoid rod 304a inserted therein and faces the movable core 308 at a predetermined interval. The spring 310 is disposed between the fixed core 309 and the movable core 308 and configured to bias the movable core 308 in the direction of opening a valve. The cylindrical member 312 has the fixed core 309 and the movable core 308 inserted therein. The cylindrical member is made up of a non-magnetic member fixed to the solenoid housing 311. The magnetic coil 313 is provided around the cylindrical member 312 and accommodated in the solenoid housing 311.

Three O rings 320a, 320b, and 320c are disposed on the outer peripheral portion of the control valve 300. These rings divide the whole region into a region receiving the pressure in the crankcase 140, a region receiving the pressure in the discharge chamber 142, and a region receiving the pressure in the suction chamber 141.

Substantially the same value is set for an effective pressure receiving area Sb of the bellows assembly 305 in the bellows extension direction, a pressure receiving area Sv of the crankcase 140 that receives a pressure from the valve hole 301c, which acts on the valve member 304, and a pressure receiving area Sr of the suction chamber 141 that receives a pressure applied to the valve member 304 in the second pressure sensing chamber 307. Thus, the pressure acting on the valve member 304 is represented by Expression (1) below.

Ps=[F+f−F(i)]/Sb (1)
Ps: pressure in suction chamber (second space)
F: bellows bias
f: biasing force of compression coil spring 310
F(i): electromagnetic force
Sb: bellows effective pressure receiving area=pressure receiving area Sv of the crankcase=pressure receiving area Sr of the suction chamber

Accordingly, the control valve 300 adjusts the opening of the pressure supply passage 145 through which the discharge chamber 142 communicates with the crankcase 140 such that the pressure Ps in the suction chamber 141 applied through the communication hole 301e is kept at a predetermined value that is determined according to the current flowing through the magnetic coil 313 based on an external signal. Thus, an amount of discharge gas introduced to the crankcase 140 is controlled. The predetermined value can be externally controlled by regulating a current flowing through the magnetic coil 313.

Moreover, the refrigerant in the crankcase 140 flows into the suction chamber 141 by way of an orifice 103c formed in a down-pressure passage 146 through which the crankcase 140 communicates with the suction chamber 141. The control valve 300 changes the pressure level in the crankcase 140 to thereby change the inclination angle of the swash plate 111, that is, a stroke of the piston 136. As a result, the discharge capacity of the variable displacement compressor 100 can be variably controlled.

When the air conditioning system is operating, that is, the variable displacement compressor 100 is operating, the current supply to the magnetic coil 313 is controlled based on an external signal, and the discharge capacity is variably controlled to keep the pressure in the suction chamber 141 at a predetermined value. The control valve 300 can optimize the pressure in the suction chamber 141 according to the external environment.

Further, when the air conditioning system is suspended, that is, the variable displacement compressor 100 is suspended, the current supply to the magnetic coil 313 is interrupted to forcibly open the pressure supply passage 145 to thereby minimize the discharge capacity of the variable displacement compressor 100.

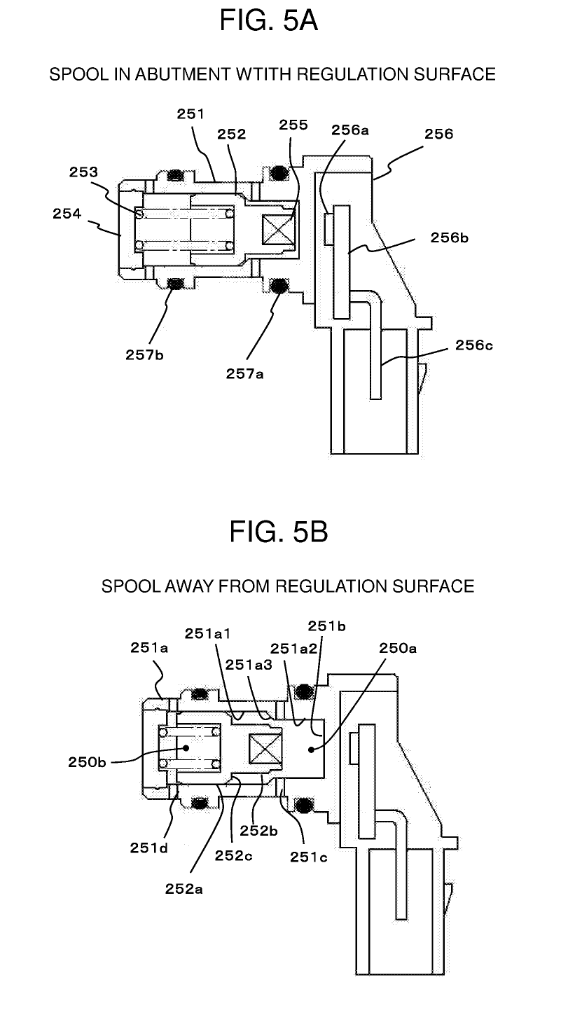

Next, the differential pressure measuring unit is discussed mainly referring to FIG. 2 and FIGS. 5A and 5B. The differential pressure measuring unit 250 incorporates a housing 251, a spool 252, a compression coil spring 253, a supporting member 254, a magnet 255, and a magnetic force measuring unit 256. The housing 251 includes a cylinder portion having a peripheral wall 251a and a bottom wall 251b and having a cylindrical inner space. The outer periphery of the spool 252 is slidably supported to the inner periphery of the peripheral wall 251a. The spool 252 is placed facing, at one end, toward the bottom wall 251b. The compression coil spring 253 serves as a biasing unit for biasing, at one end, the spool 252 toward the bottom wall 251b. The supporting member 254 is inserted and held to the housing 251 and configured to support the other end of the compression coil spring 253. The magnet 255 is fixed to one end of the spool 252. The magnetic force measuring unit 256 faces the magnet 255 across the bottom wall 251 b and serves to detect a change in magnetic flux density of the magnet 255. The differential pressure measuring unit 250 is accommodated in the accommodating hole 104c formed in the cylinder head 104 and prevented from coming off by the snap ring 153.

Provided that a first space 250a corresponds to an inner space of the housing 251 defined by one end of the spool 252 and the bottom wall 251b, and a second space 250b corresponds to an inner space of the housing 251 defined by the other end of the spool 252 and the supporting member 254, plural communication holes 251c communicating with the first space 250a and plural communication holes 251d communicating with the second space 250b are formed in the radial direction of the housing 251. These holes 251c and 251d are arranged at some interval in the circumferential direction.

Two O rings 257a and 257b are disposed around the housing 251. The differential pressure measuring unit 250 being accommodated into the accommodating hole 104c, the inner space of the accommodating hole 104c is divided into a space 104c1 communicating with the first space 250a and a space 104c2 communicating with the second space 250b. The space 104c1 communicating with the first space 250a communicates with the upstream side of the check valve 200, that is, the discharge chamber 142 through the communication passage 104d. More specifically, the communication passage 104d opens near the inlet hole 201a of the check valve 200. In addition, the space 104c2 communicating with the second space 250b communicates with the discharge passage 104a downstream of the check valve 200 through the communication passage 104e.

Accordingly, the pressure in the discharge chamber 142 upstream of the check valve 200 is introduced to the first space 250a by way of the first communication passage defined by the communication passage 104d, the space 104c1, and the communication hole 251c. Furthermore, the pressure in the discharge passage 104a downstream of the check valve 200 is introduced to the second space 250b by way of a second communication passage defined by the communication passage 104e, the space 104c2, and the communication hole 251d.

Thus, the spool 252 receives, at one end surface, the pressure in the discharge chamber 142 upstream of the check valve 200 and receives, at the other end surface, the pressure in the discharge passage 104a downstream of the check valve 200. The spool 252 moves inside the housing 251 according to a differential pressure between the upstream and downstream sides of the check valve 200. To be specific, if the differential pressure decreases, the spool 252 moves toward the bottom wall 251b. If the differential pressure increases, the spool 252 moves toward the supporting member 254.

Along with the movement of the spool 252, the position of the magnet 255 changes to thereby change the magnetic flux density of the magnet 255 measured by the magnetic force measuring unit 256, making it possible to measure a differential pressure between the upstream and downstream sides of the check valve 200. The magnetic force measuring unit 256 is configured by embedding into a resin-molded housing, a hall IC256a serving as a unit for measuring a magnetic force, an electronic circuit 256b integrated on a substrate, and an input/output terminal 256c. The magnetic force measuring unit 256 is fixed to the housing 251.

The spool 252 includes a large diameter portion 252a having an outer periphery slidably supported to an inner periphery of the housing 251, a small diameter portion 252b incorporating the magnet 255, and an annular connecting portion 252c connecting between the large diameter portion 252a and the small diameter portion 252b. In addition, the housing 251 includes a first accommodating hole 251a1 having an inner periphery slidably supporting the large diameter portion 252a of the spool, a second accommodating hole 251a2 that accommodates the small diameter portion 252b of the spool, has a smaller diameter than the first accommodating hole 251a1, and communicates with the communication hole 251c, and an annular regulation surface 251a3 extending from the inner periphery of the first accommodating hole 251a1 toward the radially inner portion and connecting the first accommodating hole 251a1 and the second accommodating hole 251a2.

When the spool 252 moves toward the bottom wall 251b, the connecting portion 252c of the spool abuts the regulation surface 251a3 to thereby regulate the movement of the spool 252 toward the bottom wall 251b along the axial direction of the spool 252 as is the same as the axial line of the peripheral wall 251a. The connecting portion 252c of the spool is constituted of an annular plane perpendicular to the axial line of the peripheral wall 251a and an inclined surface formed outside thereof. The regulation surface 251a3 is a plane perpendicular to the axial line of the peripheral wall 251a. The annular plane of the connecting portion 252c of the spool and the regulation surface 251a3 constitute an abutment portion.

The regulation surface 251a3 is a plane perpendicular to the axial line of the peripheral wall 251a, leading to the high positional accuracy for the abutment of the connecting portion 252c of the spool 252 with the regulation surface 251a3.

When the connecting portion 252c of the spool abuts the regulation surface 251a3 to regulate the movement of the spool 252, the compression coil spring 253 biases the spool 252 by a predetermined bias. The minimum operation differential pressure of the spool 252, which is determined according to the biasing force of the compression coil spring 253, is set almost equal to the differential pressure for opening the check valve 200. Therefore, the spool 252 operates as the check valve 200 opens. Even if the opening of the check valve 200 is small, the flow rate can be measured.

The minimum operation differential pressure of the spool 252 may be set to be lower than the differential pressure for opening the check valve 200. By setting the pressure this way, the flow rate can be surely measured as long as the check valve 200 is open.

If the variable displacement compressor 100 operates, the check valve 200 opens, and the refrigerant flows through the discharge passage 104a, the check valve 200 functions as a throttle. At this time, a differential pressure occurs between the upstream and downstream sides of the check valve 200. The connecting portion 252c of the spool moves away from the regulation surface 251a3 and then the spool 252 moves to a position corresponding to the differential pressure. At this time, the refrigerant is continuously leaking from the discharge chamber 142 to the discharge passage 104a downstream of the check valve 200 by way of the first communication passage, the first space 250a, a gap between the inner periphery of the housing 251 (first accommodating hole 251a1) and the outer periphery of the spool 252 (large diameter portion 252a), the second space 250b, and the second communication passage.

When the variable displacement compressor 100 is suspended and there is no differential pressure between the upstream and downstream sides of the check valve 200 or the pressure on the downstream side of the check valve 200 is higher than the upstream side, the check valve 200 closes. At this time, the connecting portion 252c of the spool abuts the regulation surface 251a3. The abutment portion prevents the first space 250a from communicating with the second space 250b by way of a gap between the inner periphery of the housing 251 and the outer periphery of the spool 252. In other words, the abutment portion substantially functions as a valve.

Accordingly, even if the pressure on the downstream side of the check valve 200 is higher than that on the upstream side, no refrigerant flows back to the discharge chamber 142 from the discharge passage 104a downstream of the check valve 200 by way of the gap between the inner periphery of the housing 251 and the outer periphery of the spool 252. No flow path bypassing the check valve 200 is formed inside the differential pressure measuring unit 251. That is, the function of the check valve 200 is not impaired.

The pressure on the downstream side of the check valve 200 becomes higher than that on the upstream side, for example, when the control valve 300 is powered OFF to minimize the discharge capacity as well as when the variable displacement compressor 100 is suspended for the long time.

Furthermore, the above embodiments are intended to merely illustrate examples of the present invention, and it is needless to say that the present invention covers various improvements and modifications to be made by those skilled in the art within the scope of the appended claims, in addition to those directly illustrated by the embodiments.

In the following, various modified examples of the above embodiments are described. In the above embodiments, the regulation surface 251a3 in the housing 251 is a plane perpendicular to the axial line of the peripheral wall 251a. However, the regulation surface is not limited thereto and can be, for example, an annular inclined surface. In addition, the regulation surface may be formed of a material different from that for the housing.

In the embodiments, the connecting portion 252c of the spool 252 comes in surface contact with the regulation surface 251a3 of the housing 251 but may come in line contact therewith. In this case, when the spool 252 is abutting with the regulation surface, the pressure receiving surface of the spool 252 can be clearly defined. This contributes to high setting accuracy for the minimum operation differential pressure at which the spool moves away from the regulation surface.

In the embodiments, the differential pressure measuring unit is integrated with the magnetic force measuring unit 256. However, the magnetic force measuring unit can be separately provided.

In the embodiments, the housing 251 accommodating the spool 252 is intended for the differential pressure measuring unit, but a housing member constituting the compressor may accommodate the spool. For example, an accommodating hole configured to accommodate a spool can be directly formed in the cylinder head.

Although the check valve 200 is disposed in the cylinder head in the embodiment, the valve can be provided in the other housing member. In the embodiments, the cylinder head 104 includes the discharge chamber 142 formed at its center and the suction chamber 141 formed around the discharge chamber 142. In the cylinder head, however, the suction chamber can be disposed at the center and encircled with the discharge chamber.

In the embodiments, the variable displacement compressor is employed. The flow rate measuring device is, however, applicable to any type of compressor.

In the above embodiments, the flow rate measuring device is disposed in the compressor but may be provided in the refrigerant passage of a refrigerator. Moreover, in the embodiments, the flow rate measuring device serves to measure the flow rate of the refrigerant but can measure that of any fluid without particular limitations.

### REFERENCE SYMBOL LIST

100 Variable displacement compressor
104a Discharge passage
104c1 Space
104c2 Space
104d Communication passage
104e Communication passage
142 Discharge chamber
200 Check valve
250 Differential pressure measuring unit
250a First space
250b Second space
251 Housing
251a1 First accommodating hole
251a2 Second accommodating hole
251a3 Regulation surface
251c Communication hole
251d Communication hole
252 Spool
252b Small diameter portion
252c Connecting portion
252d Annular groove
253 Compression coil spring
255 Magnet
256 Magnetic force measuring unit
300 Control valve

1. A flow rate measuring device that measures a flow rate of fluid passing through fluid passage which includes a check valve that opens/closes according to a differential pressure between an upstream pressure and a downstream pressure, the device comprising:
a spool configured to receive, at one pressure receiving surface, a pressure on an upstream side of the check valve and, at an opposite pressure receiving surface, a pressure on a downstream side of the check valve to slide in a cylinder such that a differential pressure therebetween balances a biasing force of a spring; and
a sensor configured to detect a position of the spool to measure the flow rate,
wherein the cylinder comprises a position regulation part configured to regulate the position of the spool in an axial direction of the spool to close a gap between the cylinder and the spool when the differential pressure is equal to or less than a predetermined value.

2. The flow rate measuring device according to claim 1, wherein the position regulation part is a regulation surface provided in an annular shape around a peripheral portion of the cylinder and configured to close the gap between the cylinder and the spool by being abutted by a peripheral portion of the spool.

3. The flow rate measuring device according to claim 2, wherein the regulation surface is a plane perpendicular to an axial line of a peripheral wall of the cylinder.

4. The flow rate measuring device according to claim 2, wherein the regulation surface and the peripheral portion of the spool are configured to abut each other annularly in line contact therewith.

5. The flow rate measuring device according to claim 1, wherein a minimum operation pressure for moving the spool away from the position regulation part is set equal to or lower than a pressure for opening the check valve.

6. A variable displacement compressor comprising the flow rate measuring device according to claim 1, which is provided on a discharge passage through which a discharge chamber communicates with an external refrigerant circuit.

7. The flow rate measuring device according to claim 2, wherein a minimum operation pressure for moving the spool away from the position regulation part is set equal to or lower than a pressure for opening the check valve.

8. A variable displacement compressor comprising the flow rate measuring device according to claim 2, which is provided on a discharge passage through which a discharge chamber communicates with an external refrigerant circuit.
